(19) United States
(12) Patent Application Publication
(10) Pub. No.: US 2025/0231060 A1
(43) Pub. Date: Jul. 17, 2025

(54) Method for Ascertaining the Fill Level of a Pipe, Analysis Unit, Flow Measuring System, and Computer Program Product

(71) Applicant: Siemens Aktiengesellschaft, Muenchen (DE)

(72) Inventors: Wilko WILKENING, Erlangen (DE); Mohamed NAIT MEZIANE, Bischheim (FR); Timo RECKWERTH, Woerth am Rhein (DE)

(21) Appl. No.: 18/851,750

(22) PCT Filed: Mar. 16, 2023
(86) PCT No.: PCT/EP2023/056745

§ 371 Date: Sep. 27, 2024

(30) Foreign Application Priority Data
Mar. 28, 2022 (DE) 10 2022 203 021.4

(51) Int. Cl. G01F 23/24; G01F 1/64

(52) U.S. Cl. CPC G01F 23/24; G01F 1/64

(57) ABSTRACT

An analysis unit, a flow measuring system that includes the analysis unit and a method for ascertaining the fill level of a pipe upon which actuatable first and second measuring electrodes are arranged and that is provided with at least one grounding electrode, where the pipe at least partly filled with a fluid, the first and second measuring electrode are excited using opposite measuring currents, at least one respective first measurement value is detected on the first and/or second measuring electrode, the first and second measuring electrode are excited using measuring currents in the same direction and a respective second measurement value is detected on the first and/or second measuring electrode, and the fill level of the pipe is ascertained using at least the first and second measurement value in accordance with the excitations.

### CROSS-REFERENCE TO RELATED APPLICATIONS

This is a U.S. national stage of application No. PCT/EP2023/056745 filed 16 Mar. 2023. Priority is claimed on German Application No. 10 2022 203 021.4 filed 28 Mar. 2022, the content of which is incorporated herein by reference in its entirety.

### BACKGROUND OF THE INVENTION

### 1. Field of the Invention

The invention relates to a method for ascertaining the fill level in a pipe, an evaluation unit with which the method can be implemented, a flow measuring system that include the evaluation unit, and relates to a computer program product with which the operating behavior of the flow measuring system can be simulated.

### 2. Description of the Related Art

US. Pub. No. 2017/131131 A1 discloses an electromagnetic flowmeter that is suitable for measuring impedance in a pipe. Numerous electrodes are arranged around the circumference of a pipe to measure its filling level. By measuring impedances at the electrodes in pairs, it is possible to establish which of the electrodes is wetted with the fluid.

International patent application WO 2008/113774 A2 discloses a method for determining the electrical conductivity of a medium via a magnetic-inductive flow measurement device. The flow measurement device has two opposing measuring electrodes, a grounding electrode, and two opposing coil arrangements. In order to detect electrical conductivity, excitation signals of different frequencies are generated and an impedance in each case prevailing between the measuring electrode and the grounding electrode is measured.

Flow measuring systems are used in numerous applications in automation technology. In addition to flow measurement itself, additional functions such as fill level measurement are also sought. At the same time, such flow measuring systems are subject to increasingly stringent requirements with regard to compactness, reliability, and cost efficiency.

### SUMMARY OF THE INVENTION

In view of the foregoing, it is an object of the invention is to provide a way of determining a fill level in a pipe that offers high measuring accuracy, is space-saving, robust, and cost-efficient, and can be integrated into the functional range of existing flow measuring systems.

This and other objects and advantages are achieved in accordance with the invention by a method for ascertaining a fill level of a pipe. The pipe accommodates a fluid that flows through the pipe during normal operation and forms a level when the pipe is partially filled, i.e., when the fill level is less than 100 percent. A first and a second drivable measuring electrode are arranged on the pipe. The measuring electrodes are drivable in that at least one electrical variable such as voltage or current intensity is specifiable there. The measuring electrodes extend in the lumen of the pipe and are wettable by the fluid. The pipe is further provided with at least one grounding electrode. The method comprises a first step in which the pipe is provided in a state at least in part filled with the fluid. In the first step, the fill level is consequently over 0 percent and the first and second measuring electrodes are wetted by the fluid.

The method further comprises a second step in which the first and second measuring electrodes are excited by applying contradirectional measuring currents. The contradirectional measuring currents have intensities with different signs, such that they bring about current flow from the first to the second measuring electrode, so implementing the “push-pull excitation” principle. In the second step, at least one first measured value is furthermore detected at each of the first and/or second measuring electrodes. The first measured value may, for example, be a voltage present at the first or second measuring electrode. The first or second measuring electrode can be provided with suitable measuring means for this purpose.

The method likewise includes a third step in which the first and second measuring electrodes are excited by applying equidirectional measuring currents. Complementarily to the second step, the measuring currents in the third step have intensities with the same sign. The measuring currents in the third step consequently bring about current flow from the first and second measuring electrodes to the first grounding electrode or vice versa, so implementing the “common-mode excitation” principle. In the third step, at least one second measured value is further detected at the first and/or second measuring electrodes. The second measured value, like the first measured value, can for example be a voltage present at the first or second measuring electrode. The first or second measuring electrode can also be provided with suitable measuring means for this purpose. The first and second measuring electrodes can be excited with direct current or with alternating current. Excitation with alternating current also comprises measuring currents with signal encoding, such as burst packets or “bursts”, frequency-modulated signals, and/or “Barker” codes.

The method furthermore includes a fourth step in which the fill level of the pipe is ascertained at least based on at least the first and second measured values that are detected in the second and third steps, respectively. Furthermore, in the fourth step, the ascertained fill level can be output to a user, such as via a display unit, or via a data interface, for example, to a higher-level control unit. The invention is based inter alia on the surprising insight that equidirectional and contradirectional measuring currents result in different characteristics that are in turn influenced by the fill level of the pipe. These characteristics are independent of the conductivity of the medium. The inventive method is suitable for ascertaining the fill level in the pipe without the electrical conductivity of the fluid being known and can be considered conductivity-agnostic. The inventive method is thus insensitive to changes in the composition of the fluid. As a consequence, the method serves to determine the fill level in the pipe independently of the conductivity or fluid. The inventive method furthermore requires a minimum of measuring electrodes or grounding electrodes and is also implementable on existing flow measuring systems. The inventive method enables, in particular by using the stated characteristics, the fill level to be ascertained substantially continuously. Compared to solutions known from the prior art, this overcomes their limitation that they only allow the level to be ascertained in discrete steps, the granularity of which is determined by the number of measuring electrodes. The inventive method therefore offers increased measuring accuracy with a reduced number of components, in particular measuring electrodes.

In one embodiment of the method, a first impedance prevailing in the fluid is ascertained in the fourth step based on the first measured value. Alternatively or additionally, a second impedance prevailing in the fluid is ascertained in the fourth step based on the second measured value. The first or second impedance can be ascertained based on voltage in each case prevailing at the corresponding measuring electrode and the intensity of the respective measuring current. Measuring means suitable for this purpose offer increased measuring accuracy. Furthermore, flow measuring systems upon which the inventive method can be performed are in any case provided with suitable measuring means on their measuring electrodes. The inventive method thus uses existing components of the flow measuring system and is consequently cost-efficient. Depending on the fill level of the pipe, the first and second impedances have differentiable characteristics whose characteristic curves scale with the conductivity prevailing in the fluid. The first and second impedances constitute reference values for one another. Irrespective of the conductivity of the fluid, characteristic curves of the associated characteristics have a qualitatively identical relative position to one another in a corresponding diagram. The inventive method consequently uses a simply detectable electrical property of the fluid to determine the filling level. Corresponding characteristics are furthermore interpolatable such that any value for the first or second impedance can be accurately evaluated. Increased measuring accuracy is consequently achieved.

The inventive method may furthermore have a fifth step in which a measured value at the first grounding electrode and/or a second grounding electrode is detected in order to identify a fall in the fill level. The fall in the fill level exposes one of the grounding electrodes such that it is no longer wetted with fluid. The detected measured value relates to an electrical variable, for example, a grounding current intensity, which drops substantially to zero as a result of the fall. The corresponding grounding electrode can be positioned for this purpose in the region of a vertex of the pipe, i.e., of the pipe cross-section. Correspondingly, a change in a measured value detected at the other grounding electrode can be detected thereon at the same time. The corresponding grounding electrode can be positioned for this purpose in the region of a low point of the pipe, for example, i.e., of the pipe cross-section. In particular, the first grounding electrode can be mounted in the region of the low point of the pipe and the second grounding electrode can be mounted in the region of the vertex of the pipe. In particular, a fall in the fill level below 100 percent can be reliably detected by positioning a measuring electrode in the vertex. Providing the fill level substantially amounts to 100 percent, there is no need to evaluate other characteristics, which saves computational effort. This in turn permits electrical energy savings, in particular if the flow measuring system has a battery-powered evaluation unit. The measuring electrodes and the at least one grounding electrode can furthermore be arranged along the pipe lying in one plane or lying one behind the other.

Furthermore, the measuring currents excited in the second and/or third steps can be of substantially the same magnitude, so implementing the symmetric excitation principle. The first and second measuring electrodes can likewise be arranged opposite one another on the pipe, i.e., maximally spaced apart. In the case of measuring currents of the same magnitude, a symmetric distribution of electrical current densities, which can be straightforwardly ascertained via the first and/or second measured values, is achieved in the fluid. In particular, the first grounding electrode can be mounted in the region of a low point on the pipe relative to the level of the fluid. In the case of measuring currents of identical magnitude, a grounding current intensity of substantially zero prevails at the first grounding electrode as the measured value in the second step. A second grounding electrode can further be mounted on the pipe at the vertex opposite the first grounding electrode. In the case of measuring currents of substantially identical magnitude, a grounding current intensity of substantially zero also prevails at the second grounding electrode at the vertex of the pipe. In the third step, in the case of measuring currents of substantially identical magnitude at the first and second measuring electrodes, a substantially identical grounding current intensity prevails at the first and second grounding electrodes when the first and second grounding electrodes are wetted by the fluid. For a corresponding fill level, in particular 100 percent fill level, a defined state is obtained that is expressed in the first and second measured values that are detected in the second and third steps. In the case of fill levels in which one of the grounding electrodes is exposed, identical electrical variables are established at the first and second measuring electrodes in the second and third steps. In particular, the first measured values at the first and second measuring electrodes are solely dependent on the conductivity of the fluid, i.e., on the impedance prevailing in the fluid. In addition, identical measured values prevail in the case of symmetric excitation in the first and optionally the second measuring electrode in the third step. The inventive method is thus capable of automatically identifying an intrinsic state in which measurement operation can be performed with elevated accuracy. The inventive method is consequently robust with regard to disruptive influences. Correspondingly, if the first measured values at the measuring electrodes deviate from one another and/or the second measured values at the measuring electrodes deviate from one another, then it is possible to identify fouling of one of the measuring electrodes or a skewed position of the flow measuring system. A corresponding warning can be output for this purpose.

Furthermore, in the second step, first measured values at the first and second measuring electrodes can be used to detect asymmetry therebetween. Asymmetry in the first measured values expresses an asymmetry in the prevailing current density distribution relative to an axis of symmetry between the first and second measuring electrodes that is therefore detectable via the first measured values at the first and second measuring electrodes. Such asymmetry can be brought about, for example, by fouling on the first and/or second measuring electrodes. Alternatively, such asymmetry can be brought about by a skewed position of the pipe, i.e., an angular offset relative to a pipe axis along which the pipe extends.

During the third step, it is possible to detect an asymmetry between the second measured values at the first and second measuring electrodes that is brought about by an asymmetry in the current density prevailing in the pipe cross-section. Fouling of the first and/or second measuring electrodes, or a skewed position of the pipe, can also be identified in this manner. Asymmetry between the measured values that are detected at the first and second grounding electrodes can likewise be detected. For example, a grounding electrode arranged in the region of a low point of the pipe may be covered with sunken fouling. In an intended operating state, however, the first and second measured values from the second or third step reflect the electrical conductivity of the fluid in the pipe. Fouling, on the other hand, results in modified characteristic curves of the electrical conductivity characteristics on common-mode excitation and push-pull excitation. Different types of fouling on the wall of the pipe or skewed positions on the pipe can thus be automatically differentiated by comparing the asymmetries ascertained in the second and third steps. Less pronounced asymmetries of the measured values at a grounding electrode in the region of the low point of the pipe and a grounding electrode in the region of a vertex of the pipe cross-section, can indicate electrical conductivities of the fluid that vary from place to place. This makes it possible, for example, to identify segregation of the fluid into differently conductive components which, on segregation, at least in part assume the form of layers in the pipe cross-section. The inventive method consequently also provides an additional diagnostic option.

Furthermore, in a further sixth step of the method, it is possible to excite measuring currents that are non-identical in magnitude, so implementing the asymmetric excitation principle. Correspondingly to the second or third step, at least one comparison measured value is detected at the first and/or second measuring electrodes in the sixth step. In particular, at least one of the measuring currents in the sixth step can be substantially equal to zero. In the event of a fall in the fill level in which the second grounding electrode is exposed, a fall in a measured value, in particular of the grounding current intensity, is detectable at the second grounding electrode and, at the same time, a rise in a measured value, in particular of the grounding current intensity, can be detected at the first grounding electrode. A change in at least one comparison measured value at the first and/or second measuring electrodes is likewise detectable at the same time. In particular, a measuring current of substantially zero can be applied alternately to the first and second measuring electrodes in the sixth step. Correspondingly, a non-zero measuring current is applied to the respective other measuring electrode, so enabling further plausibility checking of the fill level ascertained in the fourth step.

The asymmetric excitation in the second pass of the method can further be combined with the symmetric excitation in the first pass. A deviation between the fill levels ascertained in the fourth and sixth steps can furthermore be established in the inventive method. This deviation may be brought about by fouling of one of the measuring electrodes or a skewed position of the measuring electrodes and/or of at least one grounding electrode. A corresponding warning can likewise be output. The warning function implemented in this manner further increases the versatility of a flow measuring system upon which the method is performed. Alternatively or additionally, asymmetric excitation can also identify and/or compensate for an asymmetric arrangement of the first and second measuring electrodes. The inventive method can consequently also be implemented on measuring electrodes in any desired, i.e., even asymmetric, arrangement on the pipe. As a consequence, the inventive method can be retrofitted to numerous flow measuring systems.

In a further embodiment of the method, an expected value for the comparison measured value detected in the sixth step can be ascertained in a seventh step. In particular, the measuring currents in the sixth step can be configured such that they each correspond to a superposition of the measuring currents from the second and third steps. Superpositions of the first and second measured values that correspond to the respective measuring currents are accordingly ascertained in the seventh step. Superposition of a first and a second measured value from a corresponding second and third step forms the expected value for the comparison measured value detected in the sixth step. The comparison measured value is compared with the expected value in the seventh step. If a deviation between the comparison measured value and the expected value exceeds an adjustable tolerance value, then an improper operating state of the flow measuring system is identified. A warning can accordingly be output. The disclosed embodiments of the invention are based inter alia on the surprising insight that symmetric excitation and asymmetric excitation are linked to one another via the superposition principle. The inventive method can consequently be reliably and automatically checked for proper functioning.

The method in accordance with the disclosed embodiments may further comprise an eighth step in which a time gradient of a fall and/or rise in the fill level is detected. Alternatively or additionally, a duration between the fall and rise in the fill level can be detected in the eighth step. The fall or rise in the fill level can be performed via the disclosed embodiments of the methods. The presence of multiphase flow is further detected in the eighth step based on the detected temporal gradient and/or the detected duration. In multiphase flow, the fluid comprises a first component and a second component that has a lower electrical conductivity than the first component. The first component may, for example, be water and the second component air or oil and thus constitute a foreign phase to the first component. When a foreign phase, such as a bubble or a droplet, flows along a pipe wall at the first or second grounding electrode, this is identified as a fall in the fill level, as outlined for example in the second, third or fifth step. Once the foreign phase has passed by the first or second grounding electrode, this is similarly identified as a rise in the fill level. A time gradient for the fall and/or rise in the fill level is ascertained in the eighth step. The time gradient can be compared with an adjustable multiphase tolerance value. If the time gradient exceeds the multiphase tolerance value in magnitude, passage of a foreign phase in the pipe, and thus the presence of multiphase flow, is identified. The foreign phase may take the form of a gas phase or a droplet, such as an oil droplet. Alternatively or additionally, the duration for which the fill level is temporarily reduced can be ascertained in the eighth step and compared with an adjustable multiphase limit value. If the ascertained duration exceeds the multiphase limit value, then passage of a foreign phase in the fluid, and thus the presence of multiphase flow, is identified. It can furthermore be ascertained in the eighth step whether a fallen fill level returns to the previous level, so making it possible to verify the identification of multiphase flow in the pipe. Plug flow or surge flow are, for example, identifiable in the eighth step. A warning to a user or a data interface is further output in the eighth step. The inventive method is consequently suitable for performing the identification of multiphase flow during measurement operation of a flow measuring system and is consequently functionally versatile.

The method in accordance with disclosed embodiments may furthermore comprise a ninth step in which a difference between measured values from the first and second grounding electrodes is detected. These measured values can in particular be substantially synchronously output measuring currents. If a bubble or a droplet of the second component flows past eccentrically in the pipe in the region of the measuring electrodes, then the foreign phase constitutes a constriction of an electrically conductive region in the fluid. In particular during the third step, current flow of the measuring current to the first or second grounding electrode is inhibited. As a consequence, a difference between measured values that are detected at the first and second grounding electrodes is detectable in the ninth step. If the detected difference exceeds a multiphase threshold value in magnitude, then the presence of multiphase flow in the pipe is identified in the ninth step. If multiphase flow is present, a warning is output to a user or a data interface in the ninth step. In particular, “bubble flow” is identifiable in this way. This further increases the functional versatility of the method in accordance with the disclosed embodiments.

Alternatively or additionally, the position of the foreign phase can be detected in the ninth step. For this purpose, the second measured values detected in the third step, i.e., with common-mode excitation, can be evaluated together with at least one measured value at the first and/or second grounding electrodes. In the ninth step, the first and/or second grounding electrodes are, for this purpose, switched to non-grounding and provided with suitable switches for this purpose which are actuatable by the evaluation unit. In particular, it is possible to detect at which of the measuring electrodes and at least one grounding electrode the greatest change in the corresponding measured value occurs that indicates a drop in electrical conductivity in the region of the corresponding measuring electrode or grounding electrode. In particular, an electrical voltage prevailing at the corresponding measuring electrode or grounding electrode can be detected. The position of the foreign phase is identified as a sector in the pipe cross-section that is located closest to the corresponding measuring electrode or grounding electrode. In the ninth step, it is thus possible to identify the position of the foreign phase based on second measured values and at least one measured value from the first and/or second grounding electrodes.

Further alternatively or additionally, the first measured values at the measuring electrodes brought about on push-pull excitation, such as in the second step, can also be evaluated in the ninth step. These values are evaluated together with at least one measured value at the first and/or second grounding electrodes. In the ninth step, the first and/or second grounding electrodes are, for this purpose, switched to non-grounding and provided with suitable switches for this purpose that are actuatable by the evaluation unit. A position of the foreign phase along a connecting line between the first and second measuring electrodes is consequently identifiable. It is possible to identify based on the first measured values at the first and second measuring electrodes whether a foreign phase is located in the region of the connecting line. If a foreign phase is present in the region of the connecting line, then a voltage detected, for example, at the first and second measuring electrodes increases. Furthermore, depending on the sign of the at least one measured value at the first and/or second grounding electrodes, it is possible to identify whether the foreign phase is located closer to the first measuring electrode, the second measuring electrode, or in a central region of the connecting line. Accordingly, the position of the foreign phase can be ascertained in the ninth step by evaluating the measured values and the sign of the at least one measured value at the first and/or second grounding electrodes. The identified position of the foreign phase can be output to a user and/or a data interface.

The evaluations of first measured values and second measured values from the second or third step in conjunction with measured values from grounding electrodes switched to non-grounding can furthermore be compared with one another for mutual plausibility checking of detected foreign phases, and thus of any multiphase flow that is present. Overall, this enables reliable identification of multiphase flow, in particular surge flow and plug flow.

Furthermore, in the case of a substantially horizontally oriented pipe, identification of the position of the foreign phase makes it possible to ascertain which substance the foreign phase consists of. For example, in the case of a fluid having a liquid as its first component, a foreign phase predominantly present in the region of the vertex of the pipe cross-section is typically a gas or a liquid with a lower density than the first component. Liquids or solids, i.e., particles, with a higher density than the first component of the fluid, on the other hand, typically flow along a low point of the pipe cross-section. As a result, the inventive method enables a more detailed characterization of the multiphase flow to be performed automatically. An indication about the foreign phase of the multiphase flow can thus be output to a user and/or a data interface in the ninth step.

In a further embodiment of the method, signal noise is detected for the first and/or second measured values. The fill level in the pipe can be ascertained substantially continuously based on signal noise. The invention is based inter alia on the surprising insight that there is an evaluable correlation between fill level in the pipe and signal noise. The inventive method can use characteristic curves, for example, ascertained by calibration runs of the flow measuring system, for this purpose. Fill level can thus be additionally ascertained by evaluating signal noise. This enables plausibility checking of the fill level, for example, ascertained in the fourth step. The pipe can furthermore be provided with an annular first grounding electrode. The inventive method is consequently applicable to a wider range of flow measuring systems.

The second step and the third step can furthermore be performed at least in part simultaneously. In order to implement “common-mode excitation” and “push-pull excitation” at least in part simultaneously in the second or third step, the respective measuring currents can be excited at different frequencies. The measuring currents can be configured for this purpose as alternating currents with an adjustable frequency. There may be an adjustable frequency difference between the frequencies of the measuring currents in the second and third steps for straightforward differentiation. The inventive method can consequently be performed in a time-saving manner and integrated into the measurement operation of a corresponding flow measuring system. First and second measured values with substantially identical time stamps can likewise be generated in the second and third steps. Time skew inaccuracies between the second and third steps can consequently be avoided. Overall, this ensures that fill level is ascertained reliably.

In a tenth step, the inventive method can further be used by the first and/or second measuring electrodes to measure flow in the pipe by detecting voltages induced in the fluid by magnetic fields. Detection of the induced voltages constitutes the measurement operation that can be performed as intended with a flow measuring system. The tenth step can be performed in any stage of the inventive method. The tenth step can furthermore be performed at least in part simultaneously with one of the steps outlined above. The magnetic fields, and thus the induced voltages, which are detected in the tenth step can likewise have a different frequency or signal encoding than the measuring currents according to the second and/or third steps. The measured values according to the tenth step can thus be unambiguously differentiated on evaluation. Overall, the inventive method can be combined with the intended measurement operation. The functional versatility of a flow measuring system can be correspondingly increased by the inventive method. The fill level ascertained in the fourth step can furthermore be used as a correction value during flow measurement. The inventive method thus offers increased flow measurement accuracy.

The objects and advantages are likewise achieved in accordance with the invention by an evaluation unit. The evaluation unit is configured to ascertain a fill level of a pipe. The evaluation unit is likewise configured to receive and process measurement signals from measuring devices that are couplable with the evaluation unit. The measuring devices include a first measuring electrode, a second measuring electrode, and a first grounding electrode that is couplable with the evaluation unit separately or in a combined manner. The measurement signals correspond to the measured values outlined above from the measuring electrodes and/or grounding electrodes. The at least one grounding electrode serves inter alia to ground the fluid such that, in the case of common-mode excitation, current flow can occur in the fluid. For flow measurement according to the tenth step, at least one grounding electrode serves to reduce interference and limit common-mode signals. In particular, at least one of the grounding electrodes can be configured for frequency-dependent grounding, such that grounding is present, for example, for measurement in the tenth step but one of two grounding electrodes cannot lead off a measuring current for example for the measurement according to the third step. The first measuring electrode, the second measuring electrode, and the first grounding electrode can be mounted in a pipe in which the fill level is to be ascertained on an inner side of the wall such that they are wetted by a fluid. In accordance with the invention, the evaluation unit is configured to implement at least one embodiment of the above-described method. The above-described features of the inventive method consequently also apply similarly to the disclosed evaluation unit and are straightforwardly transferable thereto. The evaluation unit can be provided with a computer program product which is configured to perform a corresponding method. The evaluation unit can also alternatively or additionally be provided with a chip, microcontroller, or field programmable gate array (FPGA) via which the method in accordance with disclosed embodiment can each be implemented. The inventive method is substantially implementable on existing measuring electrodes or grounding electrodes by an evaluation unit in accordance with the invention, such as in the course of retrofitting.

The objects and advantages are also achieved in accordance with the invention by a flow measuring system comprising a first measuring electrode, a second measuring electrode, and a first grounding electrode. The first measuring electrode, the second measuring electrode, and the first grounding electrode are coupled to an evaluation unit that is likewise part of the flow measuring system. The evaluation unit is configured to ascertain a fill level in a pipe to which the first measuring electrode, the second measuring electrode, and the first grounding electrode are connected in the mounted state of the flow measuring system. In accordance with the invention, the evaluation unit of the flow measuring system is configured in accordance with the above-disclosed embodiments. The features of the inventive evaluation unit and the inventive method are therefore likewise transferable to the flow measuring system in accordance with the invention. Overall, the flow measuring system in accordance with the invention is compact and offers a wide range of functions by measuring flow through the pipe and ascertaining the fill level therein. The first and second measuring electrodes can be arranged symmetrically, i.e., substantially opposite one another on a diameter line in the case of a pipe with a circular cross-section. Alternatively, the first and second measuring electrodes can also be arranged asymmetrically on the pipe, i.e., substantially on a secant in the cross-section of the pipe. The measuring electrodes and/or the at least one grounding electrode can furthermore each be configured as capacitively coupled electrodes. The measuring electrodes or the at least one grounding electrode are, in this case, provided with an insulating layer that insulates them from the fluid. The measuring currents in the first and/or second step can further be excited with adjustable frequencies by which the dielectric properties of the fluid can be ascertained. Measurement signals for ascertaining frequency-dependent electrical or dielectric properties of the fluid can furthermore be used in the inventive method, so enabling further refinement of the flow measurement.

The objects and advantages are further more achieved in accordance with the invention by a computer program product in accordance with the invention that is configured to simulate the operating behavior of a flow measuring system that is mounted on a pipe in a measuring portion. In accordance with the invention, the computer program product has a digital model at least of the measuring portion that includes mounted there a first measuring electrode, a second measuring electrode, and a first grounding electrode. The first measuring electrode, the second measuring electrode, and the grounding electrode are thus part of the flow measuring system to be simulated. In accordance with the invention, the flow measuring system is configured in accordance with the above-described embodiments. The features of the inventive flow measuring system, the inventive evaluation unit, and of the inventive method are thus transferable to the computer program product in accordance with the invention. The computer program product may comprise commands that cause a computer upon which the computer program product is executed to simulate the operational behavior of the corresponding flow measuring system. In particular, the operational behavior of the flow measuring system can be simulated via the computer program product while an embodiment of the inventive method is implemented thereon. The inventive method can be implemented on the underlying real, i.e., physically existing, flow measuring system and/or be simulated on the digital flow measuring system, i.e., the system reproduced by the inventive computer program product.

For the purpose of simulation, the computer program product can have a physics module in which the flow measuring system is at least in part modeled. The flow measuring system can, for this purpose, be reproduced with regard to its structure and functionality, for example, in particular in the digital model that is part of the computer program product. Alternatively or additionally, the flow measuring system can also be configured as a calculation model in the physics module. The physics module can be configured to replicate inter alia the thermal or fluid dynamic behavior of the fluid and the resultant measurement behavior of the flow measuring system under adjustable operating conditions. The adjustable operating conditions include, for example, a flow velocity, a temperature of the fluid, an electrical conductivity of the fluid and/or the wall of the pipe, an electrical current flow distribution in the fluid, an item of phase information about the fluid, a thermal conductivity and/or electrical conductivity of a gas or vapor phase in the fluid, a delivery pressure in the fluid, and/or a viscosity of the fluid. The computer program product can have a data interface via which the corresponding data are specifiable via user input and/or other simulation-oriented computer programs. The computer program product can likewise have a data interface for outputting simulation results to a user and/or other simulation-oriented computer program products. It is, for example, possible via the computer program product to identify a defective measuring electrode or grounding electrode, insulating fouling of a measuring or grounding electrode, and/or an improper fitting position of a measuring or grounding electrode. In particular, the operating behavior of the flow measuring system, expressed by measurement signals at the first and/or second measuring electrodes, can be checked for plausibility by comparison with the simulated flow measurement system. Furthermore, the operating behavior of the flow measuring system can be simply modeled, i.e., recalculated with a minimum of “CFD” calculations. In particular, flow behavior in the pipe can be approximated with sufficient precision by algebraic calculation. The computer program product in accordance with the invention thus permits modeling of the underlying flow measuring system with a reduced requirement for computing power. It is consequently also possible to replicate numerous such flow measuring systems, such as in a higher-level control unit of an automation system. Overall, a particularly realistic process model of the operation of a corresponding automation system can straightforwardly be provided. The computer program product can be configured as a “digital twin” as, for example, described in document US 2017/286572 A1, the content of which is incorporated herein by reference in its entirety. The computer program product may be of monolithic configuration, i.e., completely executable on a hardware platform. Alternatively, the computer program product can be of a modular configuration and comprise a number of subprograms that are executable on separate hardware platforms and interact via a communicative data link. Such a communicative data link may be a network link, an internet link, and/or a mobile radio link. The computer program product according to the invention can furthermore test and/or optimize a flow measuring system by simulation.

The objects and advantages are additionally achieved in accordance with the invention a monitoring method for a flow measuring system. The monitoring method serves to monitor operation of a flow measuring system. The monitoring method comprises a first step in which flow measuring system is provided in an active operating state. At least one measured value that is obtained at the first and/or second measuring electrodes as a result of fluid flow in the pipe upon which the flow measuring system is mounted is likewise provided in the first step. At least one operating variable that specifies the current operating state of the flow measuring system is likewise detected and provided. The method further comprises a second step in which the at least one operating variable is provided as input to a computer program product. Based on the provided operating variable, the computer program product ascertains, in the second step, a nominal measured value that corresponds to the measured value provided in the first step. The method comprises a third step in which the nominal measured value and the measured value are compared with one another. If a difference between the measured value and the nominal measured value exceeds an adjustable threshold value in magnitude, then a warning is output to a user and/or an evaluation unit of the flow measuring system. In addition, in a fourth step, a cause for the difference between the measured value and the nominal measured value can be identified based on the nominal measured value and the measured value using an identification algorithm. The identification algorithm can, for example, be configured as a neural network. In accordance with the invention, the computer program product that is used in the second step is configured in accordance with the above-disclosed embodiments. Each of the steps of the inventive monitoring method can be executed on different hardware platforms regardless of location. Intermediate results from individual steps can be exchanged between the hardware platforms via a communicative data link, for example, via a network link, an internet link, or a radio link, in particular a mobile radio link.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below on the basis of individual embodiments in figures. The figures should be read to be mutually complementary in the respect that identical reference signs in different figures have the same technical meaning. The features of the individual embodiments may also be combined with one another. The features outlined above are furthermore combinable with the features of the embodiments shown in the figures, in which specifically:

FIG. 1 is a schematic cross-section of a first embodiment of the inventive method in a first stage;

FIG. 2 is a schematic cross-section of the first embodiment of the inventive method in a second stage;

FIG. 3 is a schematic cross-section of a second embodiment of the inventive method in a first stage;

FIG. 4 is a schematic cross-section of the second embodiment of the inventive method in a second stage;

FIG. 5 is a diagram of a fourth step of the inventive method in accordance with the first or second embodiment;

FIG. 6 is a schematic cross-section of a third embodiment of the inventive method in a first stage;

FIG. 7 is a cross-section of the third embodiment of the inventive method in a second stage;

FIG. 8 is a diagram of a fourth embodiment of the inventive method in a third stage;

FIG. 9 is a schematic cross-section of a fifth embodiment of the inventive method in a fourth stage; and

FIG. 10 is a flowchart of the method in accordance with the invention.

### DETAILED DESCRIPTION OF THE EXEMPLARY EMBODIMENTS

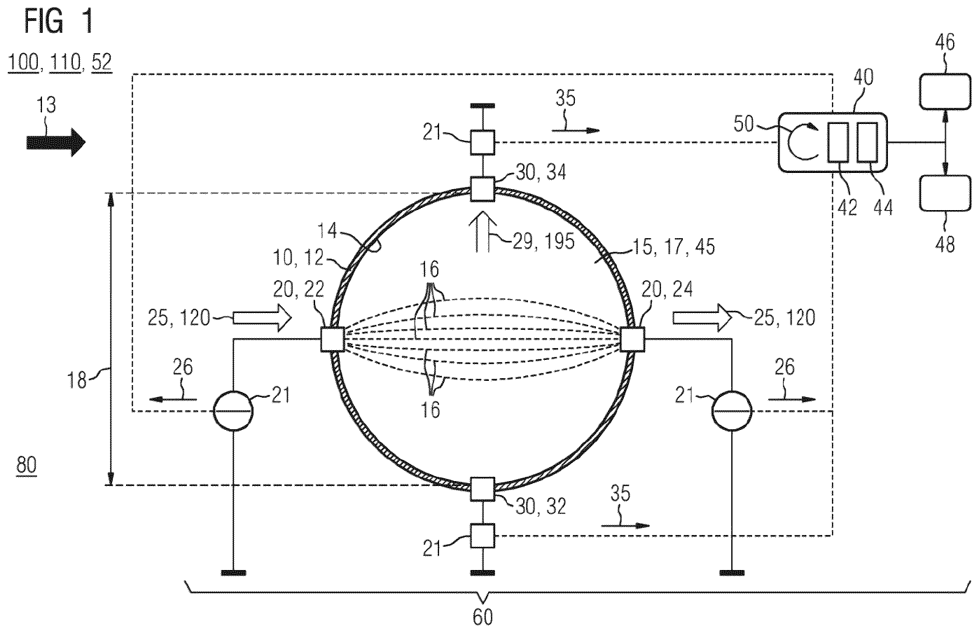

FIG. 1 depicts a cross-section of a first embodiment of the inventive method 100 in a first stage that is part of a first pass 52 of the method 100. The method 100 serves to ascertain a fill level 18 in a pipe 10 that has a wall 12 and accommodates a fluid 15 that is flowing through the pipe 10. The fill level 18 in accordance with FIG. 1 is maximum, i.e., 100 percent. The stream in pipe 10 brings about a flow 13 that is symbolized as a solid arrow in FIG. 1. The method 100 is implemented on a flow measuring system 60 that has measuring electrodes 20 positioned opposite one another on the wall 12.

The measuring electrodes 20 are drivable via an evaluation unit 40. The measuring electrodes 20 are mounted on the wall 12 of the pipe 10 such that they are wettable by the fluid 15. A first and a second measuring electrode 22, 24 are positioned substantially horizontally opposite one another. The measuring electrodes 20 are further drivable such that adjustable measuring currents 25 can be excited thereon. The flow measuring system 60 furthermore comprises grounding electrodes 30 that are arranged on the wall 12 of the pipe 10 such that they are wettable by the fluid 15. The grounding electrodes are arranged opposite one another, where a first grounding electrode 32 is positioned at a low point of the pipe 10 and a second grounding electrode 34 is positioned at a vertex of the pipe 10. Not only the measuring electrodes 20 but also the grounding electrodes 30 are each provided with measuring devices 21, each of which is configured to detect at least one electrical variable. The measuring devices 21 are each coupled with the evaluation unit 40 that is likewise part of the flow measuring system 60. The method 100 assumes an initial situation in which the pipe 10 is provided in a state at least part filled with the fluid 15 and thus a first method step 110 is completed. The fluid 15 has an electrical conductivity 17 such that impedances 45 for the measuring currents 25 result from the volume of fluid 15 present in the pipe 10, i.e., from the fill level 18.

The method 100 furthermore comprises a second step 120 in which the first and second measuring electrodes 22, 24 are excited, so bringing about contradirectional measuring currents 25. The contradirectional measuring currents 25 are of identical magnitude and implement the “push-pull excitation” principle. Furthermore, in second step 120 of the method 100, a first measured value 26 is detected at each of the first and second measuring electrodes 22, 24. The first measured values 26 are transferred to the evaluation unit 40. The evaluation unit 40 has a computing unit 42 and a control unit 44 that are configured to execute a computer program product 50 via which at least the first measured values 26 are evaluable. For push-pull excitation, as depicted in FIG. 1, an impedance 45 for the fluid 15 that can be ascertained via the first measured values 26 is obtained. The evaluation unit 40 is furthermore coupled with a display unit 46, via which ascertained results, in particular ascertained fill levels 18, can be output to a user. The evaluation unit 40 is likewise connected to a data interface 48, via which ascertained results, in particular ascertained fill levels 18, can be forwarded, for example, to a higher-level control unit (not shown). At least in part simultaneously with or with a time offset to the second step 120, a tenth step 195 is performed in the method 100 in which voltages 29 induced by magnetic fields are detected via the first measuring electrode 22, via which the flow 13, i.e., the volume of fluid 15 flowing per unit time, can be ascertained. The tenth step 195 is part of a measurement operation concomitantly with which the method 100 can be performed. The flow 13 is also ascertained by the evaluation unit 40. FIG. 1 shows a cross-section of a measuring portion along the pipe 10, where the measuring portion is modeled in a digital model that is part of a computer program product 80 that is configured to simulate the operating behavior of the flow measuring system 60. The computer program product 80 is configured as a digital twin for this purpose.

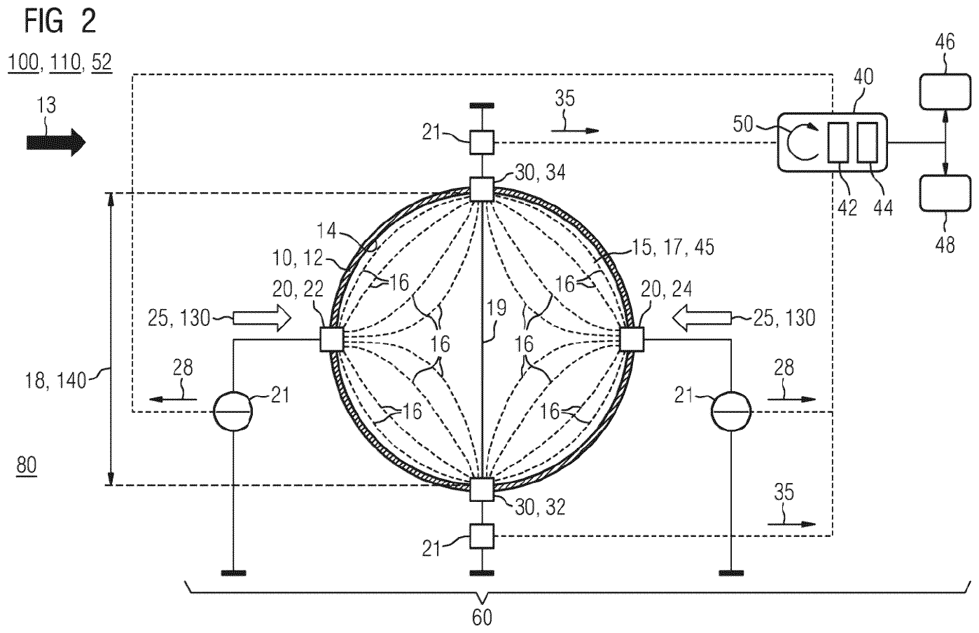

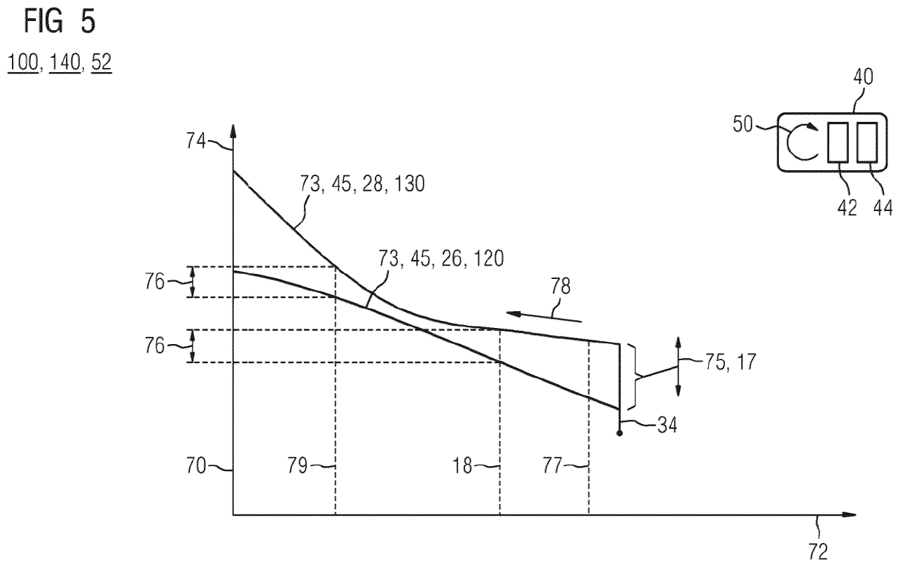

FIG. 2 shows the first embodiment of the inventive method 100 in a second stage that follows the first stage shown in FIG. 1 and is still part of the first pass 52 of the method 100. A maximum fill level 18 in the pipe 10, i.e., 100 percent, is still present. The second stage includes a third step 130 in which equidirectional measuring currents 25 are excited such that current flow arises from each of the first and second measuring electrodes 22, 24 to the first and second grounding electrodes 32, 34. The measuring currents 25 excited by the first and second measuring electrodes 22, 24 are of identical magnitude. Current flow lines 16 formed symmetrically relative to a connecting line 19 between the first and second grounding electrodes 32, 34 are obtained in the cross-section of the pipe 12. Excitation of the first and second measuring electrodes 22, 24 in the third step 130 implements the “common-mode excitation” principle. During the third step 130, second measured values 28 are detected at each of the first and second measuring electrodes 22, 24 via the measuring devices 21 and are forward to the evaluation unit 40. For the measuring currents 25 that are excited in the third step 130, impedances 45 of the fluid 15 can be ascertained based on the second measured values 28. Furthermore, a grounding current intensity at the grounding electrodes 30 is in each case detectable as the measured value 35 in the third step 130 via the measuring devices 21, where the current intensity is forwarded to the evaluation unit 40. Due to the maximum fill level 18, as shown in FIG. 1 and FIG. 2, the first and second grounding electrodes 32, 34 are wetted by the fluid 15. The presence of the maximum fill level 18 can thus be established by the measured values 35 from the first and second grounding electrodes 32, 34. The maximum fill level 18 is established based on the measured values 35 from the grounding electrodes 30 complementarily to ascertaining the fill level 18 in a fourth step 140 of the method 100. In the fourth step 140, the fill level 18 is ascertained based on the first measured values 26 and second measured values 28 via the first and second measuring electrodes 22, 24 in the second and third steps 120, 130. The first and second measured values 26, 28 from the second and third steps 120, 130 respectively provide a substantially continuous characteristic that allows the fill level 18 to be ascertained continuously. For this purpose, the first and second measured values 26, 28 from the second and third steps 120, 130 are evaluated in the evaluation unit 40 via the computer program product 50 executed therein. The fourth step 140 is depicted in greater detail below in FIG. 5. The steps depicted in FIG. 2 can also be replicated via the computer program product 80 that is configured as a digital twin and is configured to simulate the operating behavior of the flow measuring system 60.

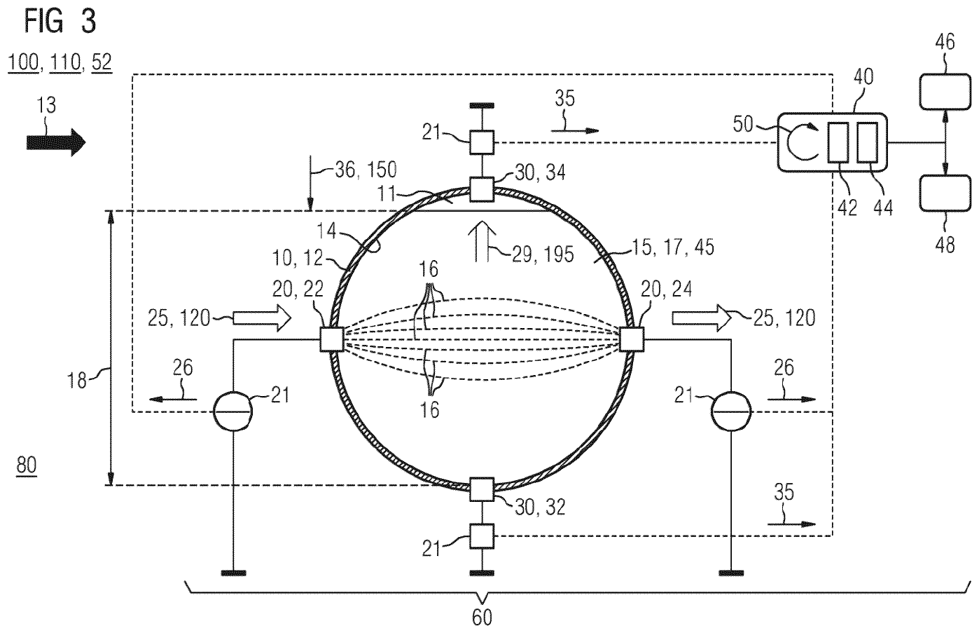

FIG. 3 depicts a second embodiment of the inventive method 100 in a first stage that is part of a first pass 52 of the method 100. The method 100 is implemented on a flow measuring system 60 that has a structure that corresponds to the flow measuring system 60 of FIG. 1 and FIG. 2. The descriptions regarding structure from FIG. 1 and FIG. 2 therefore apply similarly to FIG. 3. In FIG. 3, a first step 110 of the method 100 is completed by providing the pipe 10 in a state at least in part filled with fluid 15.

In the first stage of the method 100 in accordance with FIG. 3, a reduced fill level 18 that is below 100 percent is present. A second step 120 is further performed in the method 100 by contradirectional measuring currents 25 of identical magnitude being excited at the first and second measuring electrodes 22, 24. Due to the excited contradirectional measuring currents 25, current flow from the first measuring electrode 22 to the second measuring electrode 24 is brought about and the push-pull excitation principle is implemented. The measuring currents 25 pass through the cross-section of the pipe 10, where the fluid 15 serves as an electrical conductor. Due to the reduced fill level 18, a reduced conductor cross-section is thus available between the first and second measuring electrodes 22, 24. In the second step 120, first measured values 26 are further detected at the first and second measuring electrodes 22, 24. The first measured values 26 are characteristic of the impedances 45 prevailing in the fluid 15 on push-pull excitation. Accordingly, first measured values 26 from the second step 120 according to FIG. 3 and FIG. 1 are differentiable. A substantially continuous characteristic is thus obtained for different fill levels 18. The first measured values 26 are forwarded to the evaluation unit 40 in the second step 120.

As a result of the reduced fill level 18, a gas phase 11 is further present at the vertex of the wall 12 of the pipe 10 in the region of the second grounding electrode 34. The second grounding electrode 34 is separated from the fluid 15 by the gas phase 11. In the first stage in accordance with FIG. 3, a tenth step 195 of the method 100 is further performed by voltages 29 induced by magnetic fields being measured at the first measuring electrode 22 to ascertain the flow 13 in the pipe 10. The tenth step 195 is also implemented at least in part simultaneously with the second step 120 or with a time offset thereto. The method 100 is thus integrated in the measurement operation of the flow measuring system 60. The steps outlined in FIG. 3 can be replicated by the computer program product 80 that is configured as a digital twin and is configured to simulate the operating behavior of the flow measuring system 60.

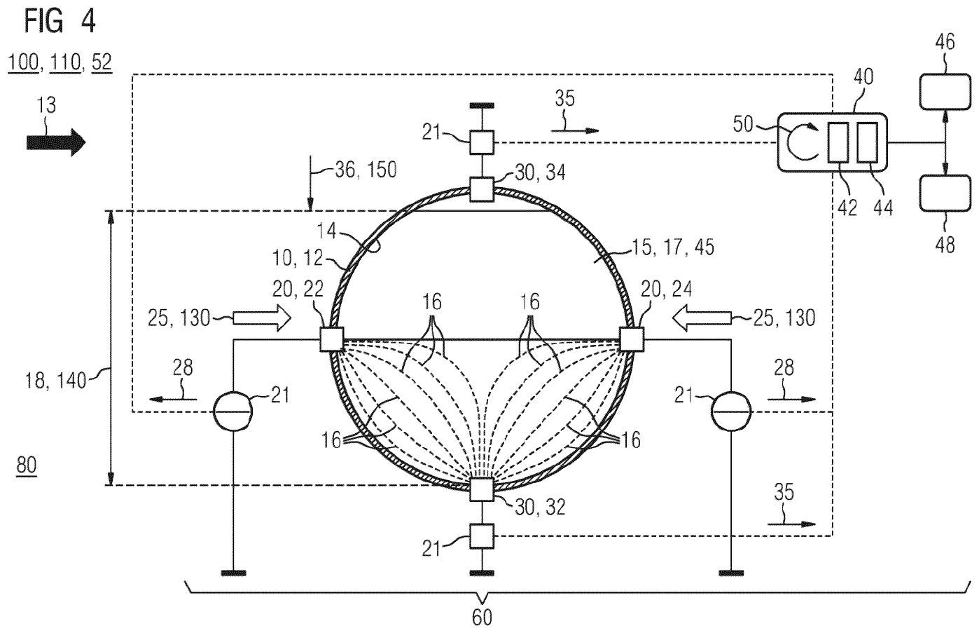

FIG. 4 shows the second embodiment of the inventive method 100 in a second stage that follows the first stage according to FIG. 3 and is likewise part of the first pass 52 of the method 100. The fill level 18 in accordance with FIG. 4 corresponds to the reduced fill level 18 as shown in FIG. 3. The structure of the flow measuring system 60 in FIG. 4 also corresponds to the structure from FIG. 3. A third step 130 is performed in the second stage of the method 100 by equidirectional measuring currents 25 of identical magnitude being excited at the first and second measuring electrodes 22, 24. Due to the gas phase 11 at the vertex of the pipe 10, i.e., at the second grounding electrode 34, current substantially flows from the first and second measuring electrodes 22, 24 to the first grounding electrode 32 in the third step 130. Accordingly, the current flow lines 16 between the measuring electrodes 20 and the first grounding electrode 32 are correspondingly dense. Due to the reduced fill level 18, a reduced conductor cross-section in the form of the fluid 15 is present in each case between the measuring electrodes 20 and the first grounding electrode 32. A substantially continuous characteristic of the impedances 45 in the fluid 15 is accordingly obtained for reduced fill levels 18. These impedances 45 can be ascertained via second measured values 28 that are detectable at the first and second measuring electrodes 22, 24. The second measured values 130 are detected in the third step 130 and forwarded to the evaluation unit 40. The first measured values 26 from the second step 120, as shown in FIG. 3, and the second measured values 28 from the third step 130 can be evaluated via the evaluation unit 40 in a fourth step 140. In particular, the prevailing fill level 18 is ascertained in the fourth step 140 based on the first and second measured values 26, 28. For this purpose, the evaluation unit 40 is provided with the computer program product 50 executed thereon. The fourth step 140 is depicted in greater detail below in FIG. 5.

A fifth step 150 is furthermore performed by the fall 36 in the fill level 18 being detected. This involves detecting at least one measured value 35 at the first and/or second grounding electrodes 32, 34. Due to the fall 36 in the fill level 18, the second grounding electrode 34, which is mounted in the region of a vertex of the pipe 10, is no longer wetted. As a result of the fall 36 in the fill level 18, the density of current lines 16 is likewise increased in the region of the first grounding electrode 32 that is arranged in the region of the low point of the pipe 10. Due to the fall 36 in the fill level 18, a measured value 35 detected at the first grounding electrode 32 thus also shows a significant change that indicates the fall 36 in the fill level 18. The steps outlined in FIG. 3 can be replicated by the computer program product 80 that is configured as a digital twin and is configured to simulate the operating behavior of the flow measuring system 60.

FIG. 5 is a diagram 70 of a fourth step 140 of the inventive method 100 that can be performed, for example, in the embodiments in accordance with FIG. 1, FIG. 2, FIG. 3, or FIG. 4. The fourth step 140 is performed in the first pass 52 of the method 100 and serves to ascertain a fill level 18 prevailing in the pipe 10 based on the first and second measured values 26, 28 that are detected in the second or third step 120, 130. For this purpose, the fourth step 140 makes use of the correlations depicted in diagram 70. Diagram 70 has a horizontal fill level axis 72 indicating a fill level 18 that rises from left to right. Diagram 70 further comprises a vertical impedance axis 74. Diagram 70 has two characteristic curves 73, each of which represents a correlation between fill level 18 and a prevailing impedance 45. The characteristic curves 73 are bounded to the left by a minimum detectable fill level 18 and to the right by a maximum detectable fill level 18. Depending on the position of the electrodes, the minimum and maximum detectable fill levels 18 can be 0 and 100 percent, respectively. The characteristic curve 73 used in the third step 130 has a step-like drop in the region of the maximum detectable fill level 18, where the drop occurs due a second grounding electrode 34 at a vertex of the pipe 12 being wetted. The characteristic curves 73 in diagram 70 can each be provided by calculation, simulation, or measurement. The characteristic curves 73 each form characteristics that describe a correlation between ascertained impedance 45 and fill level 18 for push-pull excitation or common-mode excitation in the second and third steps 120, 130 respectively of the method 100. The position of the characteristic curves 73 along the impedance axis 74 is dependent on the conductivity 17 prevailing in the fluid 15. The relative position of the characteristic curves 73 to one another is, however, the same. This results in a sliding coupling 75 related to the conductivity 17 of the fluid 15, which is symbolized by a double-headed arrow in FIG. 5. The fill level 18 is ascertained by ascertaining the respective impedances 45 based on the first and second measured values 26, 28 from the second and third steps 120, 130 and ascertaining an impedance ratio 76. The impedance ratio 76 is in turn characteristic of up to two positions along the characteristic curves 73. One of these positions represents the prevailing fill level 18 and the other position a hypothetical fill level 79. The hypothetical fill level 79 is theoretically also possible, but implausible. It can be ascertained based on a known historical value 77 for the fill level 18 that a slow downward trend 78 is more realistic than an abrupt drop to the hypothetical fill level 79. In the fourth step 140, if there are two mathematically possible fill levels, i.e., the actual fill level 18 and the hypothetical fill level 79, then the one that is closer to the known historical fill level 77 is identified as the actual fill level 18. A repetition rate at which the method 100 is performed can be adapted such that the comparison with the known historical value 77 allows a plausible differentiation to be made. The fourth step 140 permits an overall substantially continuous identification of the fill level 18 of fluid 15 in the pipe 10 irrespective of the electrical conductivity 17 prevailing in the fluid 15. The fourth step 140 is implemented via the evaluation unit 40 of the flow measuring system 60 (not shown in greater detail), for example, by the computer program product 50 executed in the evaluation unit 40.

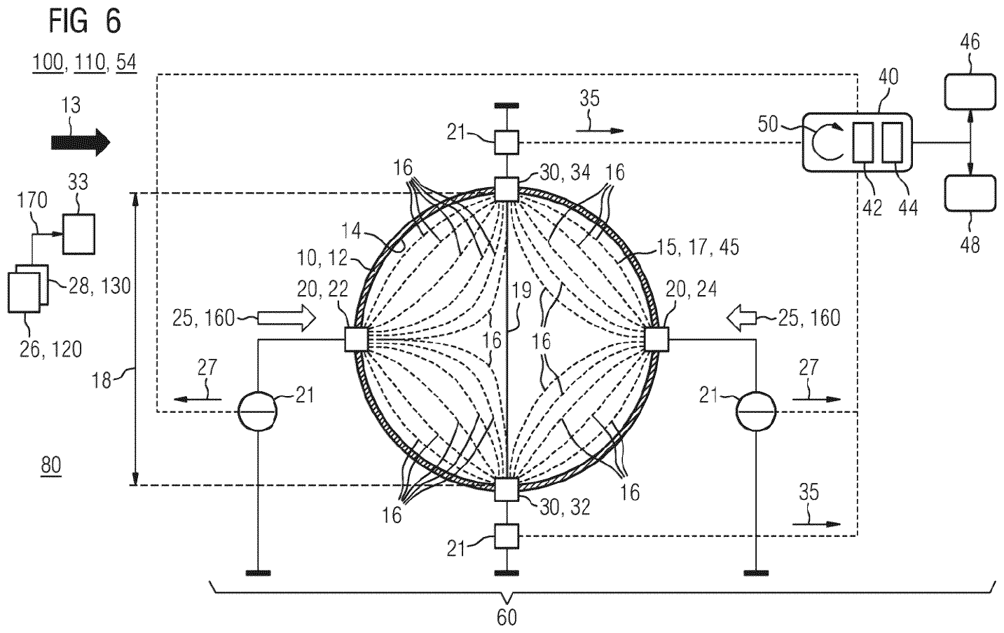

FIG. 6 is a cross-section of a third embodiment of the inventive method 100 in a first stage. The method 100 is implemented on a flow measuring system 60 that corresponds in terms of structure to the flow measuring systems 60 in accordance with FIG. 1 to FIG. 4. The maximum, i.e., 100 percent, fill level 18 is present. In the method 100 in accordance with FIG. 6, a sixth step 160 is performed by measuring currents 25 that differ in magnitude being excited at the first and second measuring electrodes 22, 24. The sixth step 160 is part of a second pass 54 of the method 100 that follows the first pass 52 in accordance with, for example, FIG. 1 to FIG. 4. As a result, current flow lines 16 formed asymmetrically relative to a connecting line 19 between the first and second grounding electrodes 32, 34 are obtained in the fluid 15. In the sixth step 160, at least one comparison measured value 27 that is forwarded to the evaluation unit 40 is likewise detected at the first and second measuring electrodes 22, 24. Measured values 35 can likewise be detected at the first and second grounding electrodes 32, 34 and forwarded to the evaluation unit 40.

A seventh step 170 is also performed in the first stage, as shown in FIG. 6. In the seventh step 170, at least one expected value 33 is ascertained from the first and second measured values 26, 28 from the second and third steps 120, 130, as depicted in FIG. 1 to FIG. 4. The at least one expected value 33 is formed in the seventh step 170 by superpositioning. The measuring currents 25 excited in the sixth step 160 likewise correspond to a superposition of the corresponding measuring currents 25 from the first pass 52. The at least one comparison measured value 27 detected in the sixth step 160 is thus compared with the corresponding expected value 33 in the seventh step 170. For this purpose, a difference is ascertained between the at least one comparison measured value 27 and the corresponding expected value 33 and is compared with an adjustable tolerance value. If the ascertained difference exceeds the adjustable tolerance value in magnitude, then a warning is output. If the difference is smaller in magnitude than the adjustable tolerance value, then an intended state of the flow measuring system 60 is identified. The sixth step 160 and seventh step 170 thus enable the presence of an improper state of the flow measuring system 60 that is integrated in the measurement operation thereof. An improper state may, for example, be a soiled measuring electrode 20, a soiled grounding electrode 30, or a displaced mounting position thereof. Asymmetric excitation thus further extends the functional range of the method 100. The operating behavior of the flow measuring system 60 can also be simulated by the computer program product 80 configured as a digital twin and can thus be further monitored for improper states.

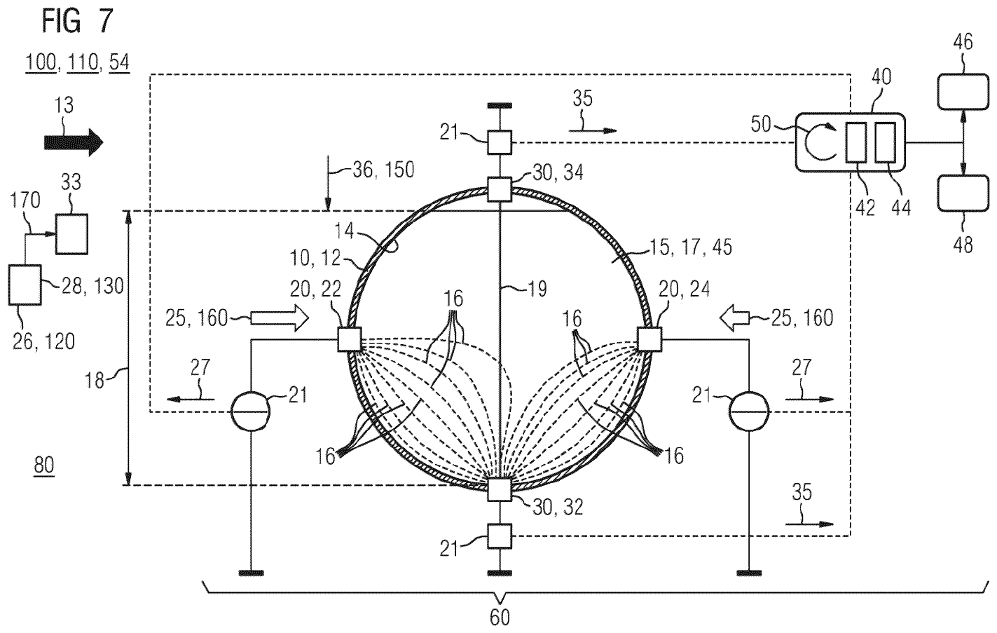

FIG. 7 shows the third embodiment of the inventive method 100 in a second stage that follows the first stage outlined in FIG. 6. The structure of the flow measuring system 60 in FIG. 7 corresponds to that of the flow measuring system 60 from FIG. 6. In comparison with the first stage, the fill level 18 is reduced in the second stage, i.e., is below 100 percent. The sixth and seventh steps 160, 170 are performed correspondingly to first stage in accordance with

FIG. 6 in the second stage, which is also part of the second pass 54 of the method 100. The measuring currents 25 excited by the first and second measuring electrodes 22, 24 are non-identical in magnitude, such that asymmetrically arranged current density lines 16 are obtained. The superposition principle can also be used in the sixth and seventh steps 160, 170 in the case of a reduced fill level 18 to check the plausibility of the fill level 18 ascertained in the first pass 52 and/or to identify an improper state of the flow measuring system 60. Equally, the operating behavior of the flow measuring system 60 in the case of a reduced fill level 18 and asymmetric excitation can be simulated in the computer program product 80 and can be further monitored for improper states.

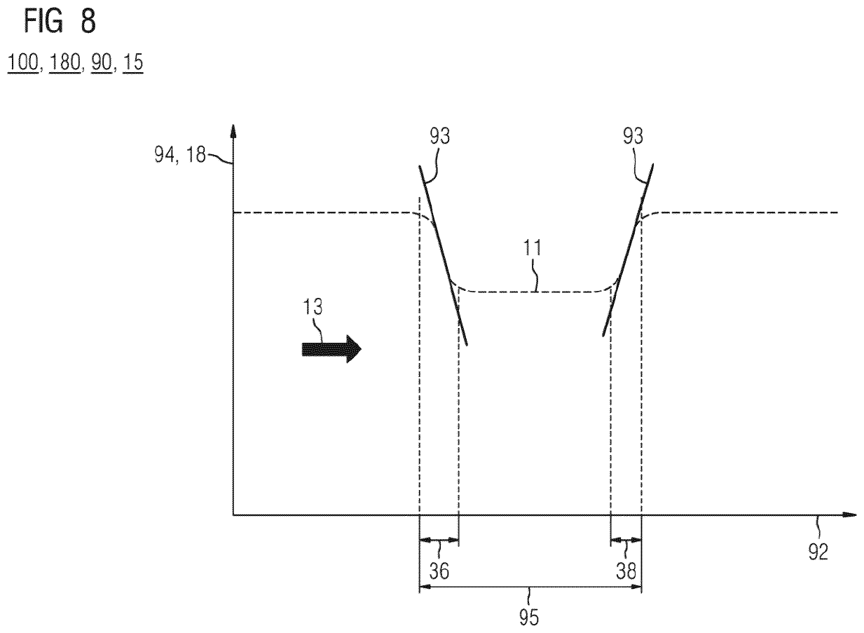

FIG. 8 is a diagram 90 of a fourth embodiment of the inventive method 100. The fourth embodiment comprises an eighth step 180 that is performed in a third stage of the method 100. The third stage can follow a second stage, as shown, for example, in FIG. 3 and FIG. 4. The eighth step serves to identify multiphase flow in the cross-section of the pipe 12. The diagram 90 has a horizontal time axis 92 and a vertical variable axis 94 on which the prevailing fill level 18 in the pipe 10 can be read.

The fill level 18 is at a substantially constant level. A gas phase 11 is moving with the flow 13 in the fluid 15. The gas phase 11 passes through a measuring portion of the pipe 10 in which are arranged at least measuring electrodes 20, as shown in FIG. 1 to FIG. 4. The inventive method 100 firstly detects a fall 36 in the fill level 18 in the pipe 10 as the gas phase 11 passes through the measuring portion. A rise 38 of the fill level 18 back up to the previous level is then detected. The fall 36 and/or rise 38 in the fill level 18 is detected in the eighth step 180. A time gradient 93 is ascertained for each fall 36 and/or rise 38 in the fill level 18. In the eighth step 180, the time gradient 93 is further compared with a multiphase tolerance value that is not shown in greater detail. If the time gradient 93 exceeds the adjustable multiphase tolerance value in magnitude, then passage of the gas phase 11 is identified. The eighth step 180 is based inter alia on the insight that gas phases 11 in the inventive method 100 lead to apparently abruptly falling or rising ascertained fill levels 18.

A duration 95 between a fall 36 and a rise 38 in the fill level 18 is alternatively or additionally detectable in the eighth step 180. Gas phases 11 typically pass through the pipe 10 in the fluid 15 at elevated velocity, such that the fill level 18 in the inventive method 100 appears to fall temporarily for a short time. The presence of multiphase flow in the pipe 10 can also be identified on this basis. The inventive method 100 can be performed sufficient rapidly for a passing gas phase 11 to be reliably identifiable. As a result, plug flow or surge flow in the pipe 10 is identifiable.

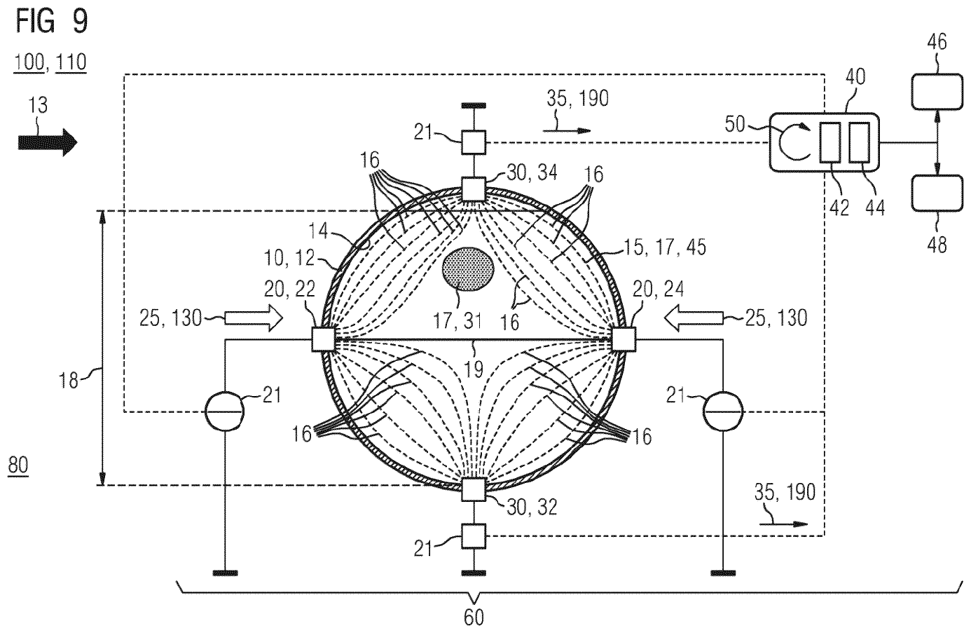

FIG. 9 is a schematic diagram of a fifth embodiment of the inventive method 100 in a fourth stage that, for example, follows the first stage, as shown in FIG. 1 or FIG. 2, or the third stage in accordance with FIG. 8. A ninth step 190 that serves to identify multiphase flow is implemented in the fifth embodiment of the inventive method 100. The flow measuring system 60 corresponds in structure to the flow measuring systems 60, as depicted in FIG. 1 to FIG. 4, FIG. 6, and FIG. 7. A foreign phase 31 in the form of a droplet, for example, of oil, is flowing through the pipe 10 with the flow 13 of fluid 15. The foreign phase 31 has a lower electrical conductivity 17 than the fluid 15. As in the third step 130 of the method 100, equidirectional measuring currents 25 are excited at the first and second measuring electrodes 22, 24 in the ninth step 190, so implementing common-mode excitation. The foreign phase 31 gives rise to asymmetric current flow lines 16 relative to a connecting line 19 extending substantially horizontally between the first and second measuring electrodes 22, 24. The foreign phase 31 thus reduces the usable conductor cross-section, i.e., the fluid 15 itself, present in the fluid 15 between the second grounding electrode 34 and the first or second measuring electrode 22, 24. In the ninth step 190, a measured value 35 is further detected at the first and at the second grounding electrodes 32, 34 and forwarded to the evaluation unit 40. The measured values 35 detected at the grounding electrodes 30 in the ninth step 190 correspond to one another, i.e., relate to the same electrical variable. A difference between the measured values 34 detected in this way at the first and second grounding electrodes 32, 34 is likewise formed in the ninth step 190. If the difference exceeds an adjustable multiphase threshold value in magnitude, then the presence of multiphase flow in the pipe 10 is identified. The ninth step 190 can be integrated in the third step 130, or can be combined in combination with the other embodiments shown. The inventive method 100 is thus also capable of identifying plug flow or surge flow. If it is known what substances make up the foreign phase 31, then a table or corresponding characteristic can also be used to ascertain a proportion by volume of the foreign phase 31 in the fluid 15.

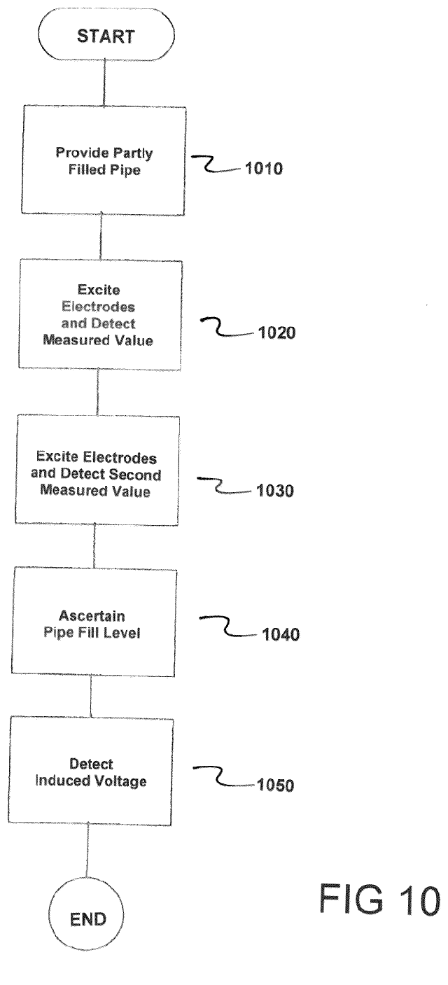

FIG. 10 is a flowchart of the method 100 for ascertaining a fill level 18 of a pipe 10 upon which first and second drivable measuring electrodes 22, 24 are arranged and which is provided with at least one grounding electrode 30, 32, 34. The method comprises a) providing the pipe 10 in a state at least in part filled with a fluid 15, as indicated in step 1010.

Next, b) the first and second measuring electrodes 22, 24 are excited with contradirectional measuring currents 25 and at least one first measured value 26 is detected at each of the first and/or second measuring electrodes 22, 24, as indicated in step 1020.

Next, c) the first and second measuring electrodes 22, 24 are excited with equidirectional measuring currents 25 and a second measured value 28 is detected at each of the first and/or second measuring electrodes 22, 24, as indicated in step 1030.

Next, d) the fill level 18 of the pipe 10 is ascertained based on at least the first and second measured values 26, 28 obtained in accordance with steps 1020 and 1030, as indicated in step 1040.

Next, j) the first and/or second measuring electrodes 22, 24 detect a voltage 29 induced in the fluid 15 by a magnetic field to measure flow 13 in the pipe 10, as indicated in step 1050.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A method for ascertaining a fill level of a pipe upon which first and second drivable measuring electrodes are arranged and which is provided with at least one grounding electrode, the method comprising:
a) providing the pipe in a state at least in part filled with a fluid;
b) exciting the first and second measuring electrodes with contradirectional measuring currents and detecting at least one first measured value at each of the first and/or second measuring electrodes;
c) exciting the first and second measuring electrodes with equidirectional measuring currents and detecting a second measured value at each of the first and/or second measuring electrodes;
d) ascertaining a fill level of the pipe based on at least the first and second measured values obtained in accordance with steps b) and c); and
j) detecting, by the first and/or second measuring electrodes, a voltage induced in the fluid by a magnetic field to measure flow in the pipe.

16. The method as claimed in claim 15, wherein during said step d) at least one of a first impedance is ascertained based on the first measured value and a second impedance is ascertained based on the second measured value.

17. The method as claimed in claim 15, further comprising:
e) detecting a measured value at at least one of the first grounding electrode and a second grounding electrode to identify a fall in the fill level.

18. The method as claimed in claim 16, further comprising:
e) detecting a measured value at at least one of the first grounding electrode and a second grounding electrode to identify a fall in the fill level.

19. The method as claimed in claim 15, wherein the measuring currents excited in at least one of step b) and c) are identical in magnitude in at least one first pass of the method.

20. The method as claimed in claim 15, further comprising:
f) exciting measuring currents in the first and/or second measuring electrodes which are non-identical in magnitude and at least one comparison measured value is detected at the first and/or second measuring electrodes.

21. The method as claimed in claim 19, further comprising:
g) forming an expected value based on the first and second measured values from the first pass, the expected value being compared with a comparison measured value.

22. The method as claimed in claim 20, further comprising:
g) forming an expected value based on the first and second measured values from the first pass, the expected value being compared with a comparison measured value.

23. The method as claimed in claim 15, further comprising:
h) detecting at least one of a time gradient of the fall, a rise in the fill level and a duration between the fall and rise, and identifying multiphase flow based on at least one of the time gradient and the duration.

24. The method as claimed in claim 15, further comprising:
i) detecting a difference between the measured values of the first and second grounding electrodes to ascertain the presence of multiphase flow.

25. The method as claimed in claim 24, wherein during step i) a position of a foreign phase in a pipe cross-section of the pipe is identified based on least one of first measured values from step b) and second measured values from step c) together with at least one measured value at the first and/or second grounding electrodes.

26. The method as claimed in claim 15, wherein signal noise is detected for the first and/or second measured values and the fill level is ascertained based on the signal noise.

27. The method as claimed in claim 15, wherein step b) and step c) are implemented at least in part simultaneously.

28. An evaluation unit for ascertaining a fill level of a pipe which is configured to receive and process measurement signals from measuring devices and which is couplable with a first measuring electrode, a second measuring electrode, and a first grounding electrode;
wherein the evaluation unit is configured to:
a) provide the pipe in a state at least in part filled with a fluid;
b) excite the first and second measuring electrodes with contradirectional measuring currents and detect at least one first measured value at each of the first and/or second measuring electrodes;
c) excite the first and second measuring electrodes with equidirectional measuring currents and detect a second measured value at each of the first and/or second measuring electrodes;
d) ascertain a fill level of the pipe based on at least the first and second measured values obtained in accordance with steps b) and c); and
j) received a voltage induced in the fluid by a magnetic field to measure flow in the pipe, said voltage being detected by the first and/or second measuring electrodes.

29. A flow measuring system comprising a first measuring electrode, a second measuring electrode, and a first grounding electrode which are coupled with an evaluation unit for ascertaining flow in a pipe, wherein the evaluation unit is configured as claimed in claim 28.

30. A computer program product for simulating an operational behavior of a flow measuring system which is mounted on a pipe in a measuring portion, and which includes a digital model at least of the measuring portion with a first measuring electrode, a second measuring electrode, and a first grounding electrode of the flow measuring system, wherein the flow measuring system is configured as claimed in claim 29.
